(19) United States
(12) Patent Application Publication
(10) Pub. No.: US 2024/0235230 A9
(43) Pub. Date: Jul. 11, 2024

(54) CHARGING SYSTEM

(71) Applicant: SONY SEMICONDUCTOR SOLUTIONS CORPORATION, KANAGAWA (JP)

(72) Inventor: KARIN UNO, KANAGAWA (JP)

(21) Appl. No.: 18/547,708

(22) PCT Filed: Jan. 13, 2022
(86) PCT No.: PCT/JP2022/000915

§ 371 Date: Aug. 24, 2023

(30) Foreign Application Priority Data
Mar. 5, 2021 (JP) 2021-035607

(51) Int. Cl. H02J 7/00

(52) U.S. Cl. CPC H02J 7/0049; H02J 7/0025; H02J 7/007182

(57) ABSTRACT

The charging system of the present disclosure includes: an electronic device having a first battery; and a charging device, in which the charging device includes a second battery that charges the first battery, a determination unit that determines whether or not the first battery is chargeable to a fully charged state, on the basis of a remaining charge amount of the first battery and a remaining charge amount of the second battery, and a charging control unit that controls a start of charging of the first battery by the second battery, on the basis of a result of the determination of the determination unit.

### TECHNICAL FIELD

The present disclosure relates to a charging system.

### BACKGROUND ART

In a charging system including a wireless earphone having an earphone battery and a case having a case battery for charging the earphone battery, there is a technique of predicting a usable time of the earphone battery on the basis of charging remaining amount information of the earphone battery and notifying a user of the usable time (see Patent Literature 1).

### CITATION LIST

### Patent Literature

Patent Literature 1: Japanese Unexamined Patent Application Publication No. 2020-108223

### SUMMARY OF THE INVENTION

In a charging system described above, whether or not a remaining charge amount of a case battery is able to sufficiently charge a wireless earphone is not determined. Accordingly, it is difficult for a user to know whether or not the wireless earphone is chargeable to a fully charged state.

It is desirable to provide a charging system that makes it possible to perform charging appropriately.

A first charging system according to one embodiment of the present disclosure includes: an electronic device having a first battery; and a charging device, in which the charging device includes a second battery that charges the first battery, a determination unit that determines whether or not the first battery is chargeable to a fully charged state, on the basis of a remaining charge amount of the first battery and a remaining charge amount of the second battery, and a charging control unit that controls a start of charging of the first battery by the second battery, on the basis of a result of the determination of the determination unit.

A second charging system according to one embodiment of the present disclosure includes: an electronic device having a first battery; a charging device having a second battery that charges the first battery; and an external device, in which the external device includes a determination unit that determines whether or not the first battery is chargeable to a fully charged state, on the basis of a remaining charge amount of the first battery and a remaining charge amount of the second battery, and a charging control unit that controls a start of charging of the first battery by the second battery, on the basis of a result of the determination of the determination unit.

In the first or the second charging system according to one embodiment of the present disclosure, whether or not the first battery is chargeable to the fully charged state is determined on the basis of the remaining charge amount of the first battery and the remaining charge amount of the second battery, and the start of the charging of the first battery by the second battery is controlled on the basis of the determination result.

### BRIEF DESCRIPTION OF THE DRAWINGS

FIG. 1 is a configuration diagram schematically illustrating a first configuration example of a charging system according to a first embodiment of the present disclosure.

FIG. 2 is a configuration diagram schematically illustrating a second configuration example of the charging system according to the first embodiment.

FIG. 3 is a flowchart schematically illustrating a first example of a charging process of the charging system according to the first embodiment.

FIG. 4 is a flowchart illustrating an example of a user notification process in the charging system according to the first embodiment.

FIG. 5 is a flowchart schematically illustrating a second example of the charging process of the charging system according to the first embodiment.

FIG. 6 is a flowchart schematically illustrating a first example of an over-discharge state determination process in the charging system according to the first embodiment.

FIG. 7 is a flowchart schematically illustrating a second example of the over-discharge state determination process in the charging system according to the first embodiment.

### MODES FOR CARRYING OUT THE INVENTION

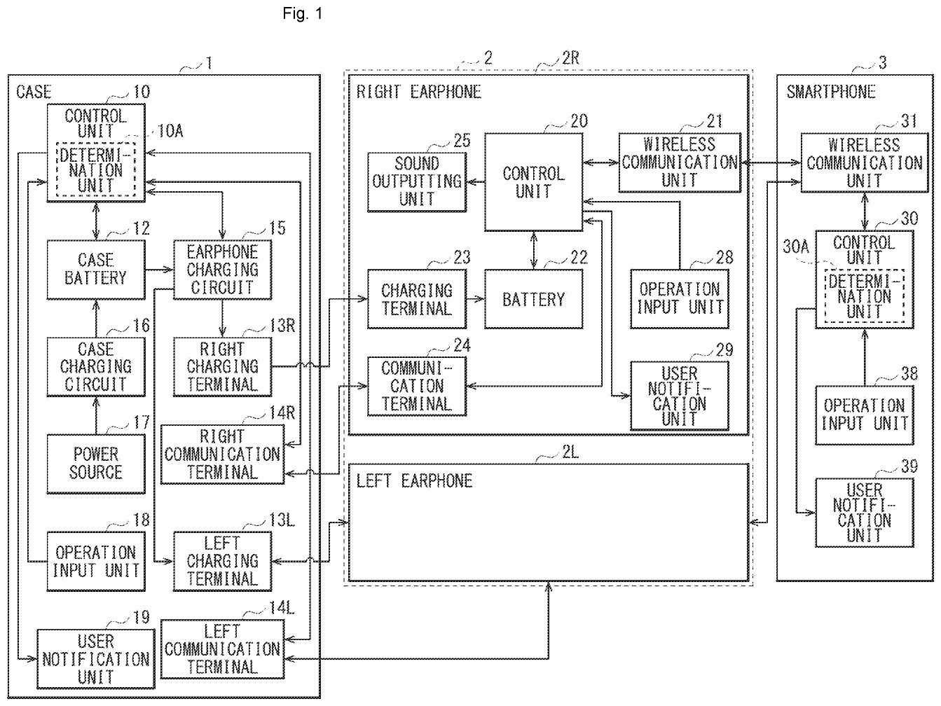

Hereinafter, some embodiments of the present disclosure are described in detail with reference to the drawings. The description will be made in the following order.
1. First Embodiment (FIG. 1 to FIG. 7)
1.1 Configuration
1.2 Operation
1.3 Effect
1.4 Modification Examples
2. Other Embodiments

### 1. First Embodiment

### 1.1 Configuration

### (First Configuration Example)

FIG. 1 schematically illustrates a first configuration example of a charging system according to a first embodiment of the present disclosure.

The charging system according to the first configuration example includes a case 1 as a charging device, an earphone 2 as an electronic device, and a smartphone 3 as an external device.

The case 1 is an earphone case having a function of accommodating the earphone 2 and a function of charging the earphone 2. The case 1 includes a control unit 10, a case battery 12 as a second battery, a right charging terminal 13R, a left charging terminal 13L, a right communication terminal 14R, a left communication terminal 14L, an earphone charging circuit 15, a case charging circuit 16, a power source 17, an operation input unit 18, and a user notification unit 19.

The control unit 10 may be configured by a microcomputer having, for example, CPU (Central Processing Unit), ROM (Read Only Memory), and RAM (Random Access Memory). In this case, a process by the control unit 10 may be achieved by the CPU executing a process based on a program stored in the ROM or the RAM.

The earphone 2 is a wireless earphone, and has a right earphone 2R and a left earphone 2L. The right earphone 2R includes a control unit 20, a wireless communication unit 21, a battery 22 as a first battery, a charging terminal 23, a communication terminal 24, a sound outputting unit 25, an operation input unit 28, and a user notification unit 29. The left earphone 2L may have a similar configuration to the right earphone 2R.

The smartphone 3 includes a control unit 30, a wireless communication unit 31, an operation input unit 38, and a user notification unit 39.

In the case 1, the case battery 12 is a battery for charging the battery 22 of the earphone 2. The case battery 12 is supplied with electric power from the power source 17 via the case charging circuit 16.

The right charging terminal 13R of the case 1 is coupled to the charging terminal 23 of the right earphone 2R in a case where the right earphone 2R is set in the case 1. The battery 22 of the right earphone 2R is supplied with the electric power from the case battery 12 via the earphone charging circuit 15, the right charging terminal 13R, and the charging terminal 23 of the right earphone 2R.

The left charging terminal 13L of the case 1 is coupled to the charging terminal 23 of the left earphone 2L in a case where the left earphone 2L is set in the case 1. The battery 22 of the left earphone 2L is supplied with the electric power from the case battery 12 via the earphone charging circuit 15, the left charging terminal 13L, and the charging terminal 23 of the left earphone 2L.

In the case 1, the operation input unit 18 includes an operation button or the like to be operated by the user.

In the case 1, the user notification unit 19 includes LED (light-emitting diode), a display unit, and the like that notify the user of various types of information. Further, the user notification unit 19 may include a voice output unit for notifying the user of various kinds of information by voice.

The right communication terminal 14R of the case 1 is coupled to the communication terminal 24 of the right earphone 2R in a case where the right earphone 2R is set in the case 1. Thus, the case 1 and the right earphone 2R are able to communicate with each other.

The left communication terminal 14L of the case 1 is coupled to the communication terminal 24 of the left earphone 2L in a case where the left earphone 2L is set in the case 1. Thus, the case 1 and the left earphone 2L are able to communicate with each other.

The wireless communication units 21 of the right earphone 2R and the left earphone 2L are able to communicate with the wireless communication unit 31 of the smartphone 3. A wireless communication between the wireless communication unit 21 and the wireless communication unit 31 may be Bluetooth (registered trademark), Wi-Fi (registered trademark), contactless communication, or the like. Further, any other communication method may be used. The case 1 is able to communicate with the wireless communication unit 31 of the smartphone 3 via the right communication terminal 14R, the communication terminal 24 of the right earphone 2R, and the wireless communication unit 21 of the right earphone 2R. The case 1 is able to communicate with the wireless communication unit 31 of the smartphone 3 via the left communication terminal 14L, the communication terminal 24 of the left earphone 2L, and the wireless communication unit 21 of the left earphone 2L.

Thus, the case 1 and the smartphone 3 are able to communicate with each other via the right earphone 2R or the left earphone 2L.

In the earphone 2, the sound output unit 25 has a sound output mechanism that outputs sound.

In the earphone 2, the operation input unit 28 includes an operation button or the like to be operated by the user.

In the earphone 2, the user notification unit 29 includes LED, a display unit, and the like that notify the user of various types of information.

In the smartphone 3, the operation input unit 38 includes an operation button or the like to be operated by the user. The smartphone 3 may include a touch panel. The operation input unit 38 may be an operation button or the like by a UI (User Interface) displayed on a display screen of the touch panel.

In the smartphone 3, the user notification unit 39 includes a display device or the like that displays a display screen for notifying the user of various kinds of information or the like. In addition, the user notification unit 39 may include a voice output unit for notifying the user of various kinds of information by voice.

In the smartphone 3, the control unit 30 may be configured by, for example, a microcomputer having CPU, ROM and RAM. In this case, a process by the control unit 30 may be achieved by the CPU executing a process based on a program stored in the ROM or the RAM.

The control unit 10 in the case 1 or the control unit 30 in the smartphone 3 corresponds to a specific example of a “charging control unit” and a “notification control unit” in a technique of the present disclosure.

The control unit 10 in the case 1 includes a determination unit 10A. In addition, the control unit 30 in the smartphone 3 may include a determination unit 30A.

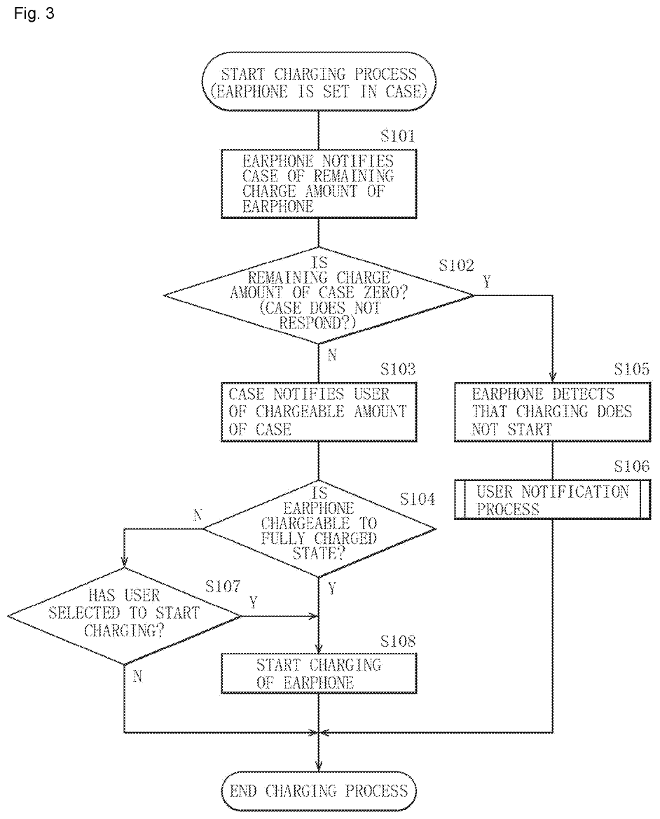

The determination unit 10A may determine whether or not the battery 22 of the earphone 2 is chargeable to a fully charged state on the basis of a remaining charge amount of the battery 22 of the earphone 2 and a remaining charge amount of the case battery 12. The control unit 10 as the charging control unit may control a start of the charging of the battery 22 of the earphone 2 by the case battery 12 on the basis of a determination result of the determination unit 10A (S104, S108, etc., of FIG. 3 to be described later).

In addition, in a case where the determination unit 10A determines that the battery 22 of the earphone 2 is chargeable to the fully charged state, the control unit 10 as the charging control unit may cause the charging of the battery 22 of the earphone 2 by the case battery 12 to be started (S104, S108, etc. of FIG. 3 to be described later).

In addition, in a case where the determination unit 10A determines that the battery 22 of the earphone 2 is not chargeable to the fully charged state, the control unit 10 as the charging control unit determines whether or not the start of the charging has been selected, and may control the start of the charging of the battery 22 of the earphone 2 by the case battery 12 on the basis of the determination result of whether or not the start of the charging has been selected (S104, S107, S108, etc., of FIG. 3 to be described later).

The control unit 10 as the charging control unit may start the charging of the battery 22 of the earphone 2 by the case battery 12 when it is determined that the start of the charging has been selected, and may not start the charging of the battery 22 of the earphone 2 by the case battery 12 when it is determined that the start of the charging has not been selected (S104, S107, S108, etc., of FIG. 3 to be described later).

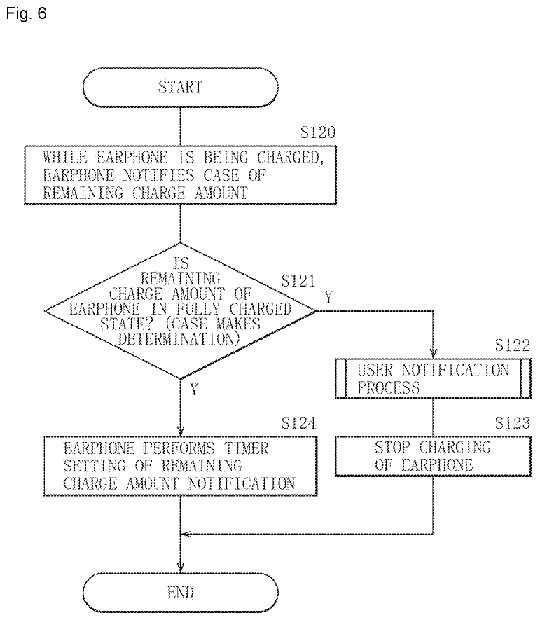

The determination unit 10A may determine whether or not the battery 22 of the earphone 2 is in the fully charged state while the battery 22 of the earphone 2 is being charged (S121 of FIG. 6 to be described later). In a case where the determination unit 10A determines that the battery 22 of the earphone 2 is in the fully charged state, the control unit 10 as the charging control unit may stop the charging of the battery 22 of the earphone 2 by the case battery 12 (S121, S123, etc., of FIG. 6 to be described later).

Further, the control unit 10 as the notification control unit may notify the result of the determination by the determination unit 10A (S103, etc., of FIG. 3 to be described later).

Further, the control unit 10 as the notification control unit may notify the earphone 2 of the result of the determination by the determination unit 10A (S103, etc., of FIG. 3 to be described later).

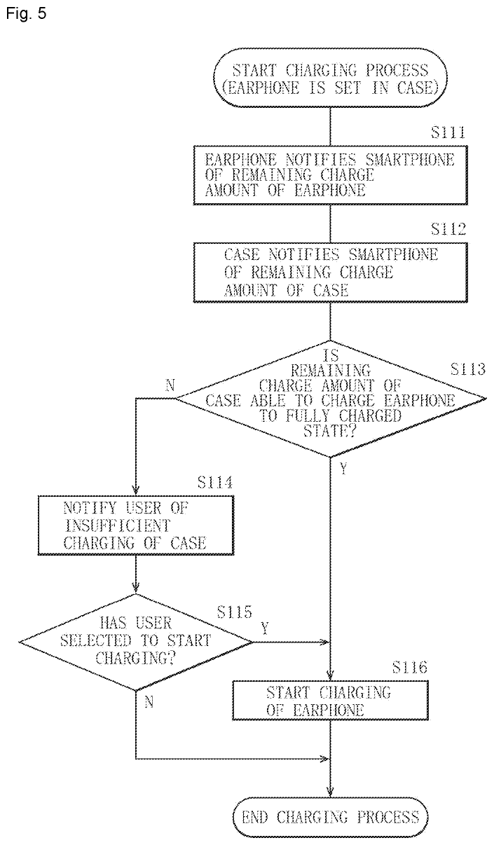

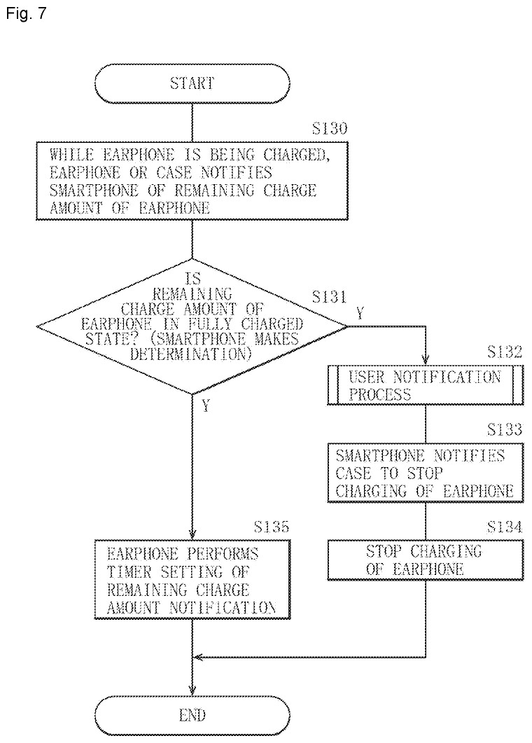

It should be noted that processes to be performed by the determination unit 10A and the control unit 10 in the case 1 described above may be performed by the determination unit 30A and the control unit 30 in the smartphone 3 (FIG. 5 and FIG. 7 to be described later).

Further, the control unit 10 as the notification control unit may notify the smartphone 3 of the result of the determination by the determination unit 10A (S103, etc., of FIG. 3 to be described later).

Further, the control unit 30 as the notification control unit may notify the case 1 of the result of the determination by the determination unit 30A (S114, etc., of FIG. 5 to be described later).

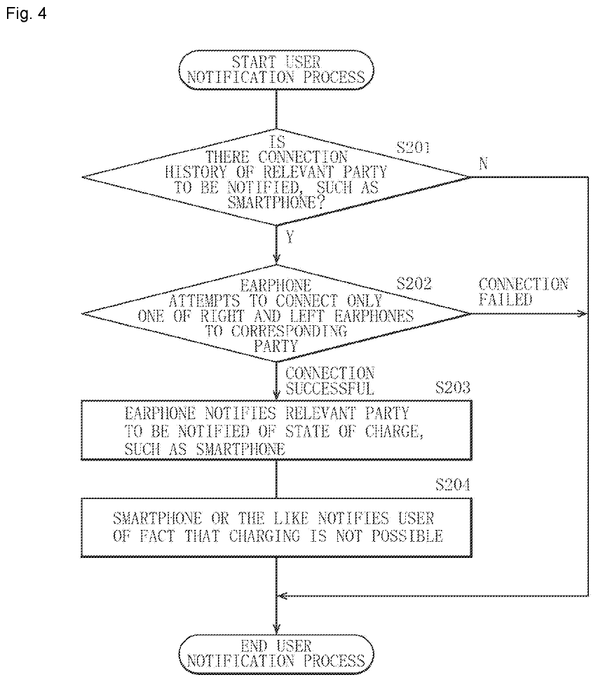

The earphone 2 may perform a process of notifying the smartphone 3 that the case 1 is in a state in which the charging is not possible, in a case where it is detected that the battery 22 of the earphone 2 is in the state in which the charging is not possible by the case 1 (S105, S106 of FIG. 3, FIG. 4, etc., to be described later).

### (Second Configuration Example)

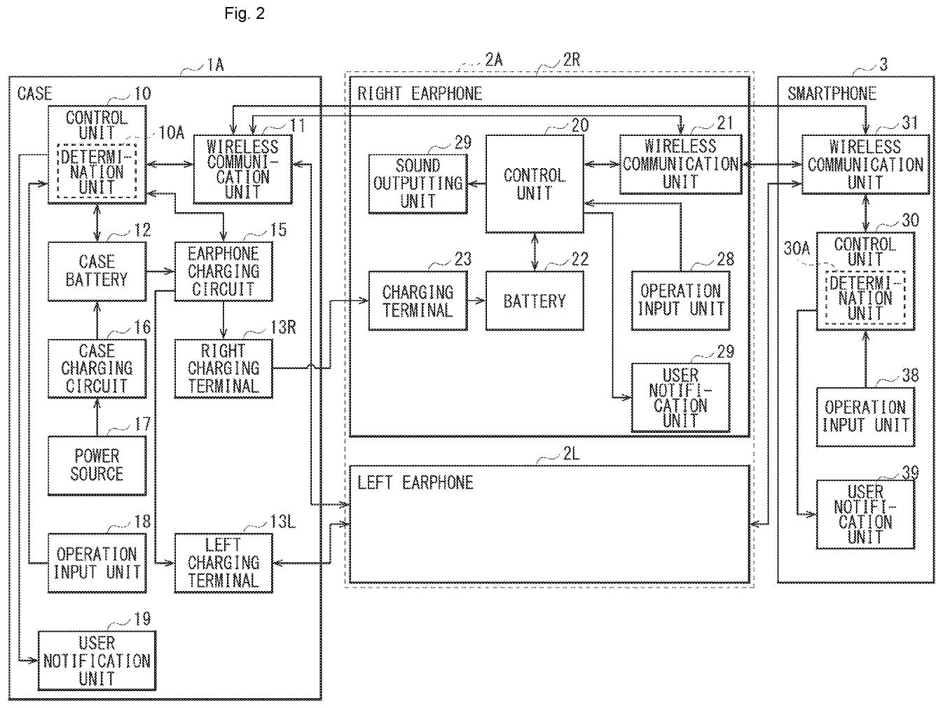

FIG. 2 schematically illustrates a second configuration example of the charging system according to the first embodiment.

The charging system according to the second configuration example includes a case 1A as the charging device, an earphone 2A as the electronic device, and the smartphone 3 as the external device.

The case 1A has a wireless communication unit 11 in place of the right communication terminal 14R and the left communication terminal 14L with respect to the configuration of the case 1 in the first configuration example of FIG. 1.

The earphone 2A has a configuration in which the communication terminal 24 is omitted from the configuration of the earphone 2 in the first configuration example of FIG. 1.

The wireless communication unit 11 of the case 1A is able to communicate with the wireless communication unit 21 of the earphone 2A and the wireless communication unit 31 of the smartphone 3. A wireless communication between the wireless communication unit 11, the wireless communication unit 21, and the wireless communication unit 31 may be Bluetooth, Wi-Fi, the contactless communication, or the like. Further, any other communication method may be used.

Thus, in the charging system according to the second configuration example, the case 1A and the earphone 2A are able to communicate with the smartphone 3 directly. As a result, the smartphone 3 is able to directly acquire information or the like on the remaining charge amounts of the case battery 12 and the battery 22 of the earphone 2 from the case 1A and the earphone 2A. In addition, it is possible to directly transmit various types of control information or the like from the smartphone 3 to the case 1A and the earphone 2A.

Other configurations may be substantially similar to the configuration of the charging system according to the first embodiment.

### 1.2 Operation

In the following description of the operation, in a case of the charging system according to the first configuration example of FIG. 1, the communication such as the notification process between the case 1 and the earphone 2 is performed via the communication terminal 24 of the earphone 2. In addition, the communication such as the notification process between the case 1 and the smartphone 3 is performed via the communication terminal 24 and the wireless communication unit 21 of the earphone 2. Further, in a case of the charging system according to the second configuration example of FIG. 2, the communication such as the notification process between the case 1A and the earphone 2A is performed by the wireless communication unit 11 of the case 1A and the wireless communication unit 21 of the earphone 2A. In addition, the communication such as the notification process between the case 1A and the smartphone 3 is performed by the wireless communication unit 11 of the case 1A and the wireless communication unit 31 of the smartphone 3.

Hereinafter, the charging system according to the first configuration example of FIG. 1 will be mainly described in operation as an example, but the operation of the charging system according to the second configuration example of FIG. 2 is basically similar to the charging system according to the first configuration example of FIG. 1 except that a communication path is different.

(First Charging Process)

FIG. 3 is a flowchart schematically illustrating a first example of a charging process of the charging system according to the first embodiment. FIG. 3 illustrates an example in which the control unit 10 of the case 1 mainly controls the start of the charging of the battery 22 of the earphone 2 by the case battery 12 on the basis of the determination result of the determination unit 10A of the case 1.

When the earphone 2 is set in the case 1, the charging process of the earphone 2 is started. First, the earphone 2 notifies the case 1 of the remaining charge amount of the earphone 2 (the battery 22) (step S101). Next, the earphone 2 determines whether or not the remaining charge amount of the case 1 (the case battery 12) is zero (whether or not the case 1 does not respond) (step S102). If it is determined that the remaining charge amount of the case 1 is zero (the case 1 does not respond) (step S102: Y), the earphone 2 detects that charging does not start (step S105), performs a user notification process to be described later (step S106), and ends the charging process.

If the earphone 2 determines that the remaining charge amount of the case 1 is not zero (the case 1 responds) (step S102: N), the case 1 notifies the user of a chargeable amount of the case 1 (step S103). A notification method may be, for example, a notification via the user notification unit 19 of the case 1 (for example, lighting by the LED). Alternatively, it may be a notification via the user notification unit 29 of the earphone 2 (for example, lighting by the LED). Alternatively, a guidance sound reproduction or the like via the sound output unit 25 of the earphone 2 may be used. Alternatively, it may be a notification (for example, a notification screen display) via the user notification unit 39 of the smartphone 3.

It should be noted that the case 1 may periodically notify the user of the chargeable amount of the case 1 other than the timing at which the charging process is started.

Next, the case 1 determines whether or not the earphone 2 is chargeable to the fully charged state (step S104). When it is determined that the earphone 2 is chargeable to the fully charged state (step S104: Y), the case 1 starts the charging of the earphone 2 (step S108), charges the earphone 2 to the fully charged state, and ends the charging process.

If it is determined that the earphone 2 is not chargeable to the fully charged state (step S104: N), the case 1 thereafter determines whether or not the user has selected to start the charging (step S107). The user may select the start of the charging, for example, by a predetermined operation (for example, a button operation) via the operation input unit 18 of the case 1. Alternatively, it may be a predetermined operation (for example, a button operation) via the operation input unit 28 of the earphone 2. Alternatively, it may be a predetermined operation (for example, a button operation) via the operation input unit 38 of the smartphone 3.

In a case where it is determined that the user has selected to start the charging (step S107: Y), the case 1 starts the charging of the earphone 2 (step S108), charges the earphone 2 to a chargeable charge capacity, and ends the charging process. If it is determined that the user has not selected to start the charging (step S107: N), the case 1 ends the charging process.

(User Notification Process)

FIG. 4 is a flow chart illustrating an example of the user notification process (4-step S106 of FIG. 3) in the charging system according to the first embodiment. The user notification process in the 4-step S106 of FIG. 3 is performed when the earphone 2 is not chargeable, the charging of the earphone 2 is forcibly terminated, or the like. Hereinafter, a process from a state in which the connection between the earphone 2 and the smartphone 3 is not established will be described.

First, the earphone 2 determines whether or not there is a connection history of a relevant party to be notified, such as the smartphone 3 (step S201). When it is determined that there is no connection history (step S201: N), the earphone 2 ends the user notification process.

If it is determined that there is a connection history (step S201: Y), the earphone 2 attempts to connect only one of the right earphone 2R and the left earphone 2L to the corresponding party (step S202). For example, the connection may be attempted by one of the right earphone 2R and the left earphone 2L having higher remaining charge amount. Further, the smartphone 3 may determine which of the right earphone 2R and the left earphone 2L is to be subjected to the connection. If the connection fails in step S202, the earphone 2 ends the user notification process.

If the connection is successful in step S202, the earphone 2 thereafter notifies the relevant party to be notified of a state of charge of the earphone 2, such as the smartphone 3 (step S203). Next, the user notification unit 29 or the like of the smartphone 3 notifies the user of the fact that charging is not possible (step S204).

(Second Charging Process)

FIG. 5 is a flowchart schematically illustrating a second example of a charging process of the charging system according to the first embodiment. FIG. 5 illustrates an example where the case battery 12 controls the start of the charging of the battery 22 of the earphone 2 on the basis of the determination result of the determination unit 30A of the smartphone 3.

When the earphone 2 is set in the case 1, the charging process of the earphone 2 is started. First, the earphone 2 notifies the smartphone 3 of the remaining charge amount of the earphone 2 (the battery 22) (step S111). It should be noted that the earphone 2 may periodically notify the user of the remaining charge amount of the earphone 2 other than the timing at which the charging process is started.

Next, the case 1 notifies the smartphone 3 of the remaining charge amount of the case 1 (the case battery 12) (step S112). Next, the smartphone 3 determines whether or not the remaining charge amount of the case 1 is able to charge the earphone 2 to the fully charged state (step S113). If the smartphone 3 determines that the earphone 2 is chargeable to the fully charged state (step S113: Y), the case 1 starts the charging of the earphone 2 (step S116), charges the earphone 2 to the fully charged state, and ends the charging process.

If it is determined that the earphone 2 is not chargeable to the fully charged state (step S113: N), the smartphone 3 thereafter notifies the user of insufficient charging of the case 1 (step S114). A notification method may be, for example, a notification (for example, a notification screen display) via the user notification unit 39 of the smartphone 3. Alternatively, it may be a notification (for example, lighting by the LED) via the user notification unit 29 of the earphone 2. Alternatively, a guidance sound reproduction or the like via the sound output unit 25 of the earphone 2 may be used. Alternatively, it may be a notification (for example, lighting by the LED) via the user notification unit 19 of the case 1.

Next, the smartphone 3 determines whether or not the user has selected to start the charging (step S115). The user may select the start of the charging, for example, by a predetermined operation (for example, a button operation) via the operation input unit 18 of the case 1. Alternatively, it may be a predetermined operation (for example, a button operation) via the operation input unit 28 of the earphone 2. Alternatively, it may be a predetermined operation (for example, a button operation) via the operation input unit 38 of the smartphone 3.

If it is determined that the user has selected to start the charging (step S107: Y), the case 1 starts the charging of the earphone 2 (step S116), charges the earphone 2 to a chargeable charge capacity, and ends the charging process. If it is determined that the user has not selected to start the charging (step S115: N), the case 1 ends the charging process.

(First Determination Process of Over-Discharge State)

FIG. 6 is a flowchart schematically illustrating a first example of an over-discharge state determination process in the charging system according to the first embodiment. FIG. 6 illustrates an example in which the determination unit 10A of the case 1 performs the over-discharge state determination process.

First, while the earphone 2 is being charged, the earphone 2 notifies the case 1 of the remaining charge amount of the earphone 2 (the battery 22) (step S120). Next, the case 1 determines whether or not the remaining charge amount of the earphone 2 is in the fully charged state (step S121). If it is determined by the case 1 that the remaining charge amount of the earphone 2 is in the fully charged state (step S121: Y), the earphone 2 performs the user notification process by a process similar to that of FIG. 4 described above (step S122). Next, the case 1 stops the charging of the earphone 2 (step S123), and ends the process.

If it is determined by the case 1 that the remaining charge amount of the earphone 2 is not in the fully charged state (step S121: N), the earphone 2 performs timer setting of the remaining charge amount notification (step S124), and ends the process.

(Second Determination Process of Over-Discharge State)

FIG. 7 is a flowchart schematically illustrating a second example of the over-discharge state determination process in the charging system according to the first embodiment. FIG. 7 illustrates an example in which the determination unit 30A of the smartphone 3 performs an over-discharge state determination process.

First, while the earphone 2 is being charged, the earphone 2 or the case 1 notifies the smartphone 3 of the remaining charge amount of the earphone 2 (the battery 22) (step S130). Next, the smartphone 3 determines whether or not the remaining charge amount of the earphone 2 is in the fully charged state (step S131). If the smartphone 3 determines that the remaining charge amount of the earphone 2 is in the fully charged state (step S131: Y), the earphone 2 performs the user notification process by a process similar to that of FIG. 4 described above (step S132). Next, the smartphone 3 notifies the case 1 to stop the charging of the earphone 2 (step S133). Next, the case 1 stops the charging of the earphone 2 (step S134), and ends the process.

If the smartphone 3 determines that the remaining charge amount of the earphone 2 is not in the fully charged state (step S131: N), the earphone 2 performs timer setting of the remaining charge amount notification (step S135), and ends the process.

### 1.3 Effects

As described above, according to the charging system of the first embodiment, it is determined whether or not the battery 22 of the earphone 2 is chargeable to the fully charged state on the basis of the remaining charge amount of the battery 22 of the earphone 2 and the remaining charge amount of the case battery 12, and the start of the charging of the battery 22 of the earphone 2 by the case battery 12 is controlled on the basis of the determination result. This makes it possible to appropriately charge the battery.

According to the charging system of the first embodiment, the user is able to know the appropriate charging timing of the case 1. Accordingly, it is possible to prevent a situation in which the earphone 2 is not chargeable contrary to the intention of the user.

According to the charging system of the first embodiment, it is possible to perform the process of determining whether or not the remaining charge amount of the case battery 12 exceeds an amount necessary for the full charging with respect to the remaining charge amount of the battery 22 of the current earphone 2, before the start of the charging of the earphone 2. If the remaining charge amount of the case battery 12 is insufficient, it is possible to notify the user. The user who has received the notification is able to select whether to charge the earphone 2 as much as possible or not. Accordingly, it is possible to prevent a situation in which the charging is performed in a case where the remaining charge amount of the battery 22 of the earphone 2 is sufficient and it is not necessary to charge the battery, or the battery 22 of the earphone 2 is not chargeable to 100% due to the insufficient remaining charge amount of the case battery 12.

Further, according to the charging system of the first embodiment, it is also possible for the earphone 2 and the case 1 to have a mechanism that periodically notifies the smartphone 3 or the like of the remaining charge amount. In this case, it is also possible for the smartphone 3 to calculate whether or not the full charging is possible by the case 1. In addition, by periodically monitoring the remaining charge amount of the battery 22 of the earphone 2 during the charging, it is possible to notify the user before the over-discharge. This allows the user to choose to stop the charging before the over-discharging.

It is to be noted that the effects described in the present specification are merely illustrative and not limitative, and there may be other effects. This applies similarly to the effects of other embodiments.

### 1.4 Modification Examples

In the above description, an example has been described in which the electronic device is the wireless earphone, the charging device is the earphone case having the function of charging the wireless earphone, and the external device is the smartphone 3, but the electronic device, the charging device, and the external device are not limited to these examples. A technique according to the present disclosure is applicable to any charging system including a first device having a battery as the electronic device and a second device having a communication function and a power supply function for the first device. Further, the technique according to the present disclosure is applicable, for example, even for a configuration in which the right earphone 2R and the left earphone 2L are independent from each other. In this case, the technique according to the present disclosure is applicable to each of the right earphone 2R and the left earphone 2L.

### 2. Other Embodiments

A technique according to the present disclosure is not limited to the description of the foregoing embodiment, and may be modified in a variety of ways.

For example, the present technology may also have the following configurations.

According to the present technology having the following configurations, it is determined whether or not a first battery is chargeable to a fully charged state on the basis of a remaining charge amount of the first battery and a remaining charge amount of a second battery, and a start of charging of the first battery by the second battery is controlled on the basis of a result of the determination. Accordingly, it is possible to appropriately charge a battery.

(1)

A charging system including:
an electronic device having a first battery; and
a charging device, in which the charging device includes
   a second battery that charges the first battery,
   a determination unit that determines whether or not the first battery is chargeable to a fully charged state, on the basis of a remaining charge amount of the first battery and a remaining charge amount of the second battery, and
   a charging control unit that controls a start of charging of the first battery by the second battery, on the basis of a result of the determination of the determination unit.
      (2)

The charging system according to (1), in which, in a case where the determination unit determines that the first battery is chargeable to the fully charged state, the charging control unit starts the charging of the first battery by the second battery.

(3)

The charging system according to (1) or (2), in which, in a case where the determination unit determines that the first battery is not chargeable to the fully charged state, the charging control unit determines whether or not the start of the charging is selected, and controls the start of the charging of the first battery by the second battery on the basis of a result of the determination as to whether or not the start of the charging is selected.

(4)

The charging system according to (3), in which the charging control unit starts the charging of the first battery by the second battery in a case where the start of the charging is determined as being selected, and does not start the charging of the first battery by the second battery in a case where the start of the charging is determined as not being selected.

(5)

The charging system according to any one of (1) to (4), in which the charging device further includes a notification control unit that notifies the result of the determination by the determination unit.

(6)

The charging system according to (5), in which the notification control unit notifies the electronic device of the result of the determination by the determination unit.

(7)

The charging system according to (5), in which the notification control unit notifies an external device of the result of the determination by the determination unit.

(8)

The charging system according to any one of (1) to (7), in which the electronic device performs a process of notifying the external device that the charging device is not chargeable, in a case of detecting that the charging device is unable to charge the first battery.

(9)

The charging system according to any one of (1) to (8), in which
the determination unit determines whether or not the first battery is in the fully charged state during the charging of the first battery, and
the charging control unit stops the charging of the first battery by the second battery in a case where the determination unit determines that the first battery is in the fully charged state.
   (10)

A charging system including:
an electronic device having a first battery;
a charging device having a second battery that charges the first battery; and
an external device, in which the external device includes
   a determination unit that determines whether or not the first battery is chargeable to a fully charged state, on the basis of a remaining charge amount of the first battery and a remaining charge amount of the second battery, and
   a charging control unit that controls a start of charging of the first battery by the second battery, on the basis of a result of the determination of the determination unit.
      (11)

The charging system according to (10), in which, in a case where the determination unit determines that the first battery is chargeable to the fully charged state, the charging control unit starts the charging of the first battery by the second battery.

(12)

The charging system according to (10) or (11), in which, in a case where the determination unit determines that the first battery is not chargeable to the fully charged state, the charging control unit determines whether or not the start of the charging is selected, and controls the start of the charging of the first battery by the second battery on the basis of a result of the determination as to whether or not the start of the charging is selected.

(13)

The charging system according to (12), in which the charging control unit starts the charging of the first battery by the second battery in a case where the start of the charging is determined as being selected, and does not start the charging of the first battery by the second battery in a case where the start of the charging is determined as not being selected.

(14)

The charging system according to any one of (10) to (13), in which the external device further includes a notification control unit that notifies the result of the determination by the determination unit.

(15)

The charging system according to (14), in which the notification control unit notifies the electronic device of the result of the determination by the determination unit.

(16)

The charging system according to (14), in which the notification control unit notifies the charging device of the result of the determination by the determination unit.

(17)

The charging system according to any one of (10) to (16), in which
the determination unit determines whether or not the first battery is in the fully charged state during the charging of the first battery, and
the charging control unit stops the charging of the first battery by the second battery in a case where the determination unit determines that the first battery is in the fully charged state.

The present application claims the benefit of Japanese Priority Patent Application JP2021-35607 filed with the Japan Patent Office on Mar. 5, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A charging system comprising:
an electronic device having a first battery; and
a charging device, wherein the charging device includes
a second battery that charges the first battery,
a determination unit that determines whether or not the first battery is chargeable to a fully charged state, on a basis of a remaining charge amount of the first battery and a remaining charge amount of the second battery, and
a charging control unit that controls a start of charging of the first battery by the second battery, on a basis of a result of the determination of the determination unit.

2. The charging system according to claim 1, wherein, in a case where the determination unit determines that the first battery is chargeable to the fully charged state, the charging control unit starts the charging of the first battery by the second battery.

3. The charging system according to claim 1, wherein, in a case where the determination unit determines that the first battery is not chargeable to the fully charged state, the charging control unit determines whether or not the start of the charging is selected, and controls the start of the charging of the first battery by the second battery on a basis of a result of the determination as to whether or not the start of the charging is selected.

4. The charging system according to claim 3, wherein the charging control unit starts the charging of the first battery by the second battery in a case where the start of the charging is determined as being selected, and does not start the charging of the first battery by the second battery in a case where the start of the charging is determined as not being selected.

5. The charging system according to claim 1, wherein the charging device further comprises a notification control unit that notifies the result of the determination by the determination unit.

6. The charging system according to claim 5, wherein the notification control unit notifies the electronic device of the result of the determination by the determination unit.

7. The charging system according to claim 5, wherein the notification control unit notifies an external device of the result of the determination by the determination unit.

8. The charging system according to claim 1, wherein the electronic device performs a process of notifying the external device that the charging device is not chargeable, in a case of detecting that the charging device is unable to charge the first battery.

9. The charging system according to claim 1, wherein
the determination unit determines whether or not the first battery is in the fully charged state during the charging of the first battery, and
the charging control unit stops the charging of the first battery by the second battery in a case where the determination unit determines that the first battery is in the fully charged state.

10. A charging system comprising:
an electronic device having a first battery;
a charging device having a second battery that charges the first battery; and
an external device, wherein the external device includes
a determination unit that determines whether or not the first battery is chargeable to a fully charged state, on a basis of a remaining charge amount of the first battery and a remaining charge amount of the second battery, and
a charging control unit that controls a start of charging of the first battery by the second battery, on a basis of a result of the determination of the determination unit.

11. The charging system according to claim 10, wherein, in a case where the determination unit determines that the first battery is chargeable to the fully charged state, the charging control unit starts the charging of the first battery by the second battery.

12. The charging system according to claim 10, wherein, in a case where the determination unit determines that the first battery is not chargeable to the fully charged state, the charging control unit determines whether or not the start of the charging is selected, and controls the start of the charging of the first battery by the second battery on a basis of a result of the determination as to whether or not the start of the charging is selected.

13. The charging system according to claim 12, wherein the charging control unit starts the charging of the first battery by the second battery in a case where the start of the charging is determined as being selected, and does not start the charging of the first battery by the second battery in a case where the start of the charging is determined as not being selected.

14. The charging system according to claim 10, wherein the external device further comprises a notification control unit that notifies the result of the determination by the determination unit.

15. The charging system according to claim 14, wherein the notification control unit notifies the electronic device of the result of the determination by the determination unit.

16. The charging system according to claim 14, wherein the notification control unit notifies the charging device of the result of the determination by the determination unit.

17. The charging system according to claim 10, wherein
the determination unit determines whether or not the first battery is in the fully charged state during the charging of the first battery, and
the charging control unit stops the charging of the first battery by the second battery in a case where the determination unit determines that the first battery is in the fully charged state.
